(19) United States
(12) Patent Application Publication
(10) Pub. No.: US 2025/0392959 A1
(43) Pub. Date: Dec. 25, 2025

(54) SYSTEMS AND METHODS FOR RADAR EVENT CLASSIFICATION AND NETWORK MANAGEMENT BASED THEREFROM

(71) Applicant: PLUME DESIGN, INC., Palo Alto, CA (US)

(72) Inventors: Badri Srinivasan SAMPATHKUMAR, Fremont, CA (US); Zhicheng ZHU, Bellingham, WA (US)

(21) Appl. No.: 18/753,285

(22) Filed: Jun. 25, 2024

(51) Int. Cl. H04W 28/086; G01S 11/02; H04W 28/02; H04W 64/00

(52) U.S. Cl. CPC H04W 28/086; G01S 11/02; H04W 28/0226; H04W 64/006

(57) ABSTRACT

Disclosed are computerized systems and methods for classification between radar events related to managing and controlling the network configuration and the connectivity of UE based therefrom. The disclosed framework operates to utilize inferred false alarm rates to determine or discern a classification and/or proportionality of the effects of factors of interest, which can impact a local network (e.g. zip code, day of week, time of day, location interference, and the like) to the false alarm rate. Accordingly, as discussed herein, the disclosed framework can compile controls and/or executable instructions that can manipulate, modify and/or optimize networks within particular regions of interest (or “decision regions”), such that, among other technical controls, can alter the DFS mode settings of APs, UEs and/or WiFi networks as a whole for particular locations.

### FIELD OF THE DISCLOSURE

The present disclosure relates to a decision intelligence (DI)-based computerized framework for classification between radar events for managing and controlling configurations of the network connectivity of user equipment (UE) based therefrom.

### SUMMARY OF THE DISCLOSURE

Wireless Fidelity (WiFi or Wi-Fi, used interchangeably) systems can operate in certain ranges that may conflict and/or overlap with critical radio communications—for example, a WiFi system may operate in the 5 GHz frequency range, which overlaps with other critical radio communications, such as weather radar, military radar, and cellular communications. To reduce the potential interference to these radio communications, WiFi standards can enforce the dynamic frequency selection (DFS) feature on all its access points (APs) for such overlapping channels (e.g., DFS channels). To achieve this, mechanisms can be implemented to cause APs to continuously monitor the radar activities, whereby such APs can only use a DFS channel when no radar event is found. When a radar is detected on an operating DFS channel, APs must switch to other channels.

Under conventional mechanisms, having an accurate and computationally efficient radar detection framework is a challenging issue for current WiFi systems. For example, to pass the regulated DFS testing, a WiFi product may be tuned to achieve a high true positive rate at the cost of a high false positive rate. As a result, many current WiFi systems suffer from the high false radar events, which subsequently limit the channel selection and increase the network interference.

To that end, the disclosed systems and methods provide a novel computerized framework that can utilize inferred false alarm rates to determine or discern a classification and/or proportionality of the effects of factors of interest, which can impact a local network (e.g. zip code, day of week, time of day, location interference, and the like) to the false alarm rate. Accordingly, as discussed herein, the disclosed framework can compile controls and/or executable instructions that can manipulate, modify and/or optimize networks within particular regions of interest (or “decision regions”), such that, among other technical controls, can alter the DFS mode settings of APs, UEs and/or WiFi networks as a whole for particular locations.

By way of example, according to some non-limiting example embodiments, as discussed herein, if a relationship between a hardware model (e.g., PP203X, for example) and a high false alarm rate is significant (e.g., at or above a percentage and/or proportionality) in region of interest during a time window (e.g., zip code 12345 on Wednesday morning when the interference is greater than 10%), then the disclosed framework can operate (e.g., in real-time and/or automatically without user input) can trigger an optimization for APs, UEs and/or WiFi networks as a whole within such region, such that DFS Radar Channel Usage can be avoided for all locations that satisfy such conditions at a prior time proximate to the time window (e.g., on Tuesday night). In some embodiments, for example, such optimization (e.g., control and/or management) instructions can cause a reset of the DFS capabilities on each WiFi network in the region to enable for all optimizations after Wednesday morning. By performing such operations, the disclosed framework can provide WiFi networks and/or other DFS overlapping networks (e.g., the critical networks, as discussed supra, for example) with functionality and/or capabilities to avoid the potential disruptions to the network on Wednesday morning due to the false radar alarm.

Accordingly, as discussed herein, the disclosed framework can operate to provide an improved DFS detection system, whereby false alarms and/or DFS disruptions can be predicted or anticipated and/or avoided altogether, thereby protecting and securing the integrity of such networks operating in such frequency bands. In some embodiments, the radar event data and/or executed/performed actions can be published, which can be in a raw data format (for further analysis by the instant framework to fine-tune its results and/or further train its AI/ML models, and/or for third party systems), but can also be formatted to display for viewing, inter alia, the radar pattern of a region (e.g., time of a day, day of a week, and the like), radar types (e.g., fix or transient radar), radar occupancy rates for different channels, and the like, or some combination thereof.

According to some embodiments, a method is disclosed for classification between radar events for managing and controlling network connectivity of UE based therefrom. In accordance with some embodiments, the present disclosure provides a non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device cause at least one processor to perform a method for classification between radar events for managing and controlling network connectivity of UE based therefrom.

In accordance with one or more embodiments, a system is provided that includes one or more processors and/or computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### DESCRIPTIONS OF THE DRAWINGS

The features and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example configuration within which the systems and methods disclosed herein could be implemented according to some embodiments of the present disclosure;

FIG. 2 is a block diagram illustrating components of an exemplary system according to some embodiments of the present disclosure;

FIG. 3 illustrates an exemplary workflow according to some embodiments of the present disclosure;

FIG. 4 depicts an exemplary implementation of an architecture according to some embodiments of the present disclosure;

FIG. 5 depicts an exemplary implementation of an architecture according to some embodiments of the present disclosure; and

FIG. 6 is a block diagram illustrating a computing device showing an example of a client or server device used in various embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ different architectures or may be compliant or compatible with different protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth, 802.11b/a/g/n/ac/ax/be, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device, a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

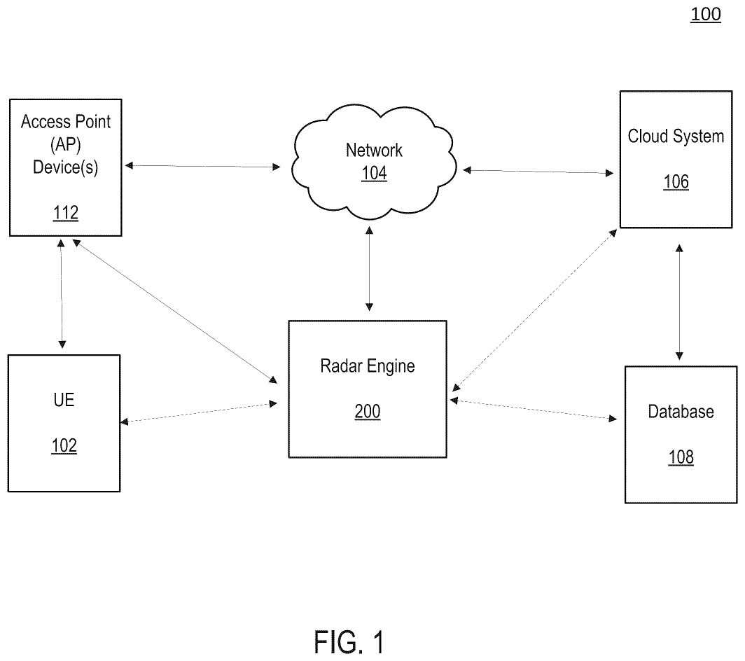

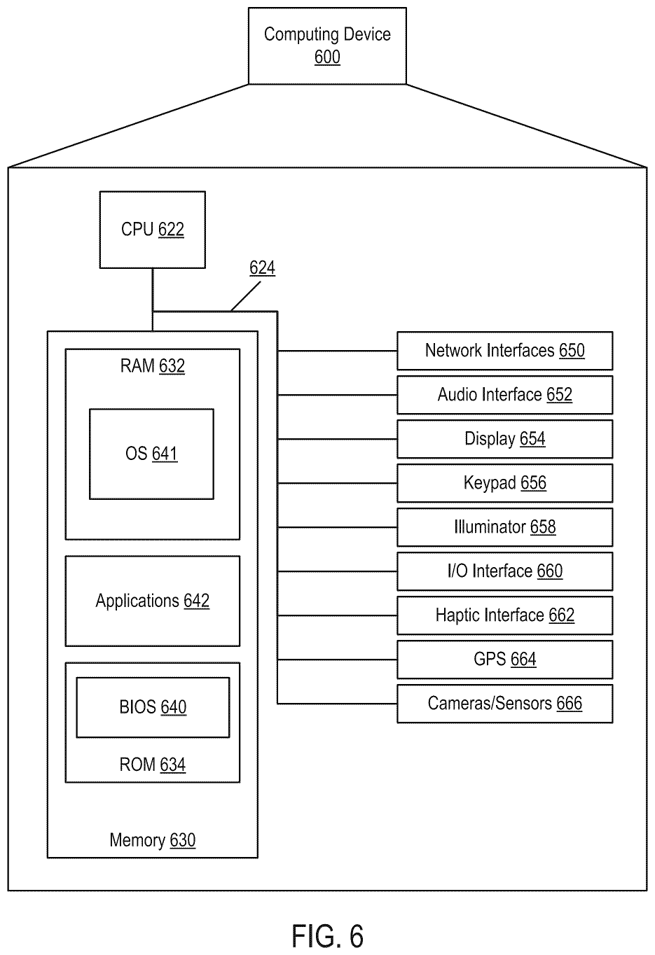

Certain embodiments and principles will be discussed in more detail with reference to the figures. With reference to FIG. 1, system 100 is depicted which includes user equipment (UE) 102 (e.g., a client device, as mentioned above and discussed below in relation to FIG. 6), AP device (or AP, used interchangeably) 112, network 104, cloud system 106, database 108 and radar engine 200. It should be understood that while system 100 is depicted as including such components, it should not be construed as limiting, as one of ordinary skill in the art would readily understand that varying numbers of UEs, AP devices, peripheral devices, sensors, cloud systems, databases and networks can be utilized; however, for purposes of explanation, system 100 is discussed in relation to the example depiction in FIG. 1.

According to some embodiments, UE 102 can be any type of device, such as, but not limited to, a mobile phone, tablet, laptop, sensor, Internet of Things (IoT) device, wearable device, autonomous machine, smart television, media streaming device, game console, and any other device equipped with a cellular or wireless or wired transceiver. In some embodiments, UE 102 can be an access point.

In some embodiments, peripheral devices (not shown) can be connected to UE 102, and can be any type of peripheral device, such as, but not limited to, a wearable device (e.g., smart ring, smart watch, for example), printer, speaker, sensor, and the like. In some embodiments, a peripheral device can be any type of device that is connectable to UE 102 via any type of known or to be known pairing mechanism, including, but not limited to, WiFi, Bluetooth™, Bluetooth Low Energy (BLE), NFC, and the like.

In some embodiments, UE 102 can correspond to, but not be limited to, any type of device, component and/or sensor associated with a location of system 100 (referred to, collectively, as “sensors”). In some embodiments, the UE 102 can be any type of device that is capable of sensing and capturing data/metadata related to activity of the location. For example, the UE 102 can include, but not be limited to, cameras, motion detectors, door and window contacts, heat and smoke detectors, passive infrared (PIR) sensors, time-of-flight (ToF) sensors, and the like. In some embodiments, the sensors can be associated with devices associated with the location of system 100, such as, for example, lights, smart locks, garage doors, smart appliances (e.g., thermostat, refrigerator, television, personal assistants (e.g., Alexa®, Nest®, for example)), smart phones, smart watches or other wearables, tablets, personal computers, and the like, and some combination thereof. In some embodiments, UE 102 can be associated with any device connected and/or operating on cloud system 106 (e.g., a cloud-based device, such as a server that collects information related to the location, for example).

According to some embodiments, AP device 112 is a device that creates and/or provides a wireless local area network (WLAN) for the location. According to some embodiments, the AP device 112 can be, but is not limited to, a router, switch, hub, gateway, extender and/or any other type of network hardware that can project a WiFi signal to a designated area. In some embodiments, UE 102 may be an AP device.

In some embodiments, network 104 can be any type of network, such as, but not limited to, a wireless network, cellular network, the Internet, and the like (as discussed above). Network 104 facilitates connectivity of the components of system 100, as illustrated in FIG. 1.

According to some embodiments, cloud system 106 may be any type of cloud operating platform and/or network based system upon which applications, operations, and/or other forms of network resources may be located. For example, system 106 may be a service provider and/or network provider from where services and/or applications may be accessed, sourced or executed from. For example, system 106 can represent the cloud-based architecture associated with a smart home or network provider (e.g., Plume Design®, for example), which has associated network resources hosted on the internet or private network (e.g., network 104), which enables (via engine 200) the network management discussed herein.

In some embodiments, cloud system 106 may include a server(s) and/or a database of information which is accessible over network 104. In some embodiments, a database 108 of cloud system 106 may store a dataset of data and metadata associated with local and/or network information related to a user(s) of the components of system 100 and/or each of the components of system 100 (e.g., UE 102, AP device 112, and the services and applications provided by cloud system 106 and/or radar engine 200).

In some embodiments, for example, cloud system 106 can provide a private/proprietary management platform, whereby engine 200, discussed infra, corresponds to the novel functionality system 106 enables, hosts and provides to a network 104 and other devices/platforms operating thereon.

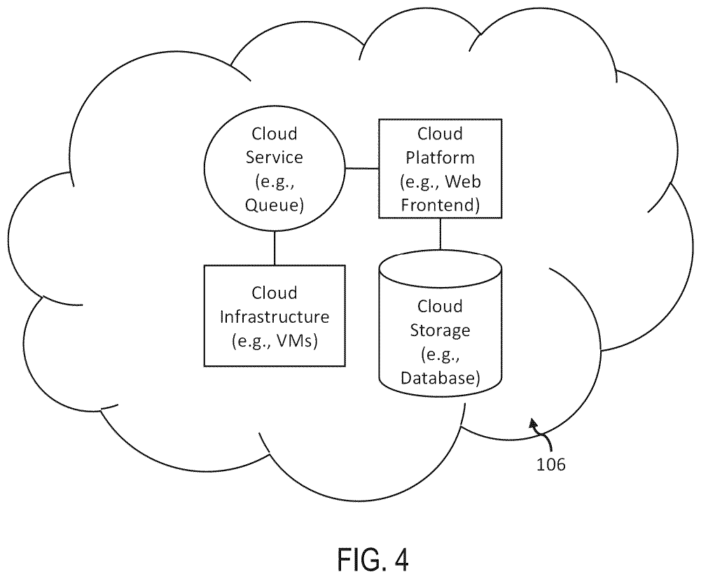

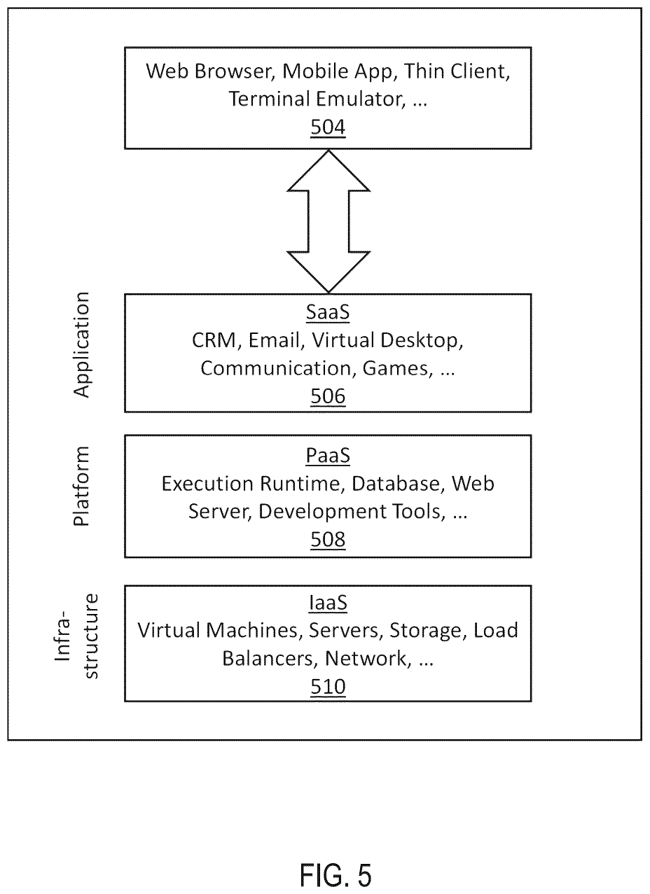

Turning to FIGS. 4 and 5, in some embodiments, the exemplary computer-based systems/platforms, the exemplary computer-based devices, and/or the exemplary computer-based components of the present disclosure may be specifically configured to operate in a cloud computing/architecture 106 such as, but not limiting to: infrastructure as a service (IaaS) 510, platform as a service (PaaS) 508, and/or software as a service (SaaS) 506 using a web browser, mobile app, thin client, terminal emulator or other endpoint 504. FIGS. 4 and 5 illustrate schematics of non-limiting implementations of the cloud computing/architecture(s) in which the exemplary computer-based systems for administrative customizations and control of network-hosted application program interfaces (APIs) of the present disclosure may be specifically configured to operate.

Turning back to FIG. 1, according to some embodiments, database 108 may correspond to a data storage for a platform (e.g., a network hosted platform, such as cloud system 106, as discussed supra) or a plurality of platforms. Database 108 may receive storage instructions/requests from, for example, engine 200 (and associated microservices), which may be in any type of known or to be known format, such as, for example, structured query language (SQL). According to some embodiments, database 108 may correspond to any type of known or to be known storage, for example, a memory or memory stack of a device, a distributed ledger of a distributed network (e.g., blockchain, for example), a look-up table (LUT), and/or any other type of secure data repository.

Radar engine 200, as discussed above and further below in more detail, can include components for the disclosed functionality. According to some embodiments, radar engine 200 may be a special purpose machine or processor, and can be hosted by a device on network 104, within cloud system 106, on AP device 112 and/or on UE 102. In some embodiments, engine 200 may be hosted by a server and/or set of servers associated with cloud system 106.

According to some embodiments, as discussed in more detail below, radar engine 200 may be configured to implement and/or control a plurality of services and/or microservices, where each of the plurality of services/microservices are configured to execute a plurality of workflows associated with performing the disclosed network management. Non-limiting embodiments of such workflows are discussed and provided below.

According to some embodiments, as discussed above, radar engine 200 may function as an application provided by cloud system 106. In some embodiments, engine 200 may function as an application installed on a server(s), network location and/or other type of network resource associated with system 106. In some embodiments, engine 200 may function as an application installed and/or executing on AP device 112 and/or UE 102. In some embodiments, such application may be a web-based application accessed by AP device 112 and/or UE 102, and/or devices accessible over network 104 from cloud system 106. In some embodiments, engine 200 may be configured and/or installed as an augmenting script, program or application (e.g., a plug-in or extension) to another application or program provided by cloud system 106 and/or executing on AP device 112 and/or UE 102. Accordingly, as provided below, engine 200 can execute on a device, at a network location, on nodes of a network and/or across a network, on differing components to perform the operations of each module executing therein.

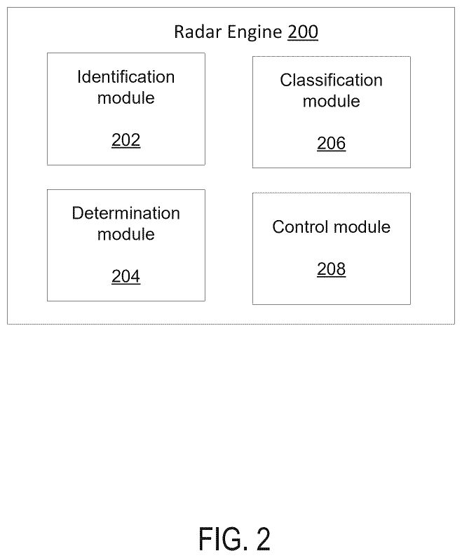

As illustrated in FIG. 2, according to some embodiments, radar engine 200 includes identification module 202, determination module 204, classification module 206 and control module 208. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 200 and each of its modules, and their role within embodiments of the present disclosure will be discussed below.

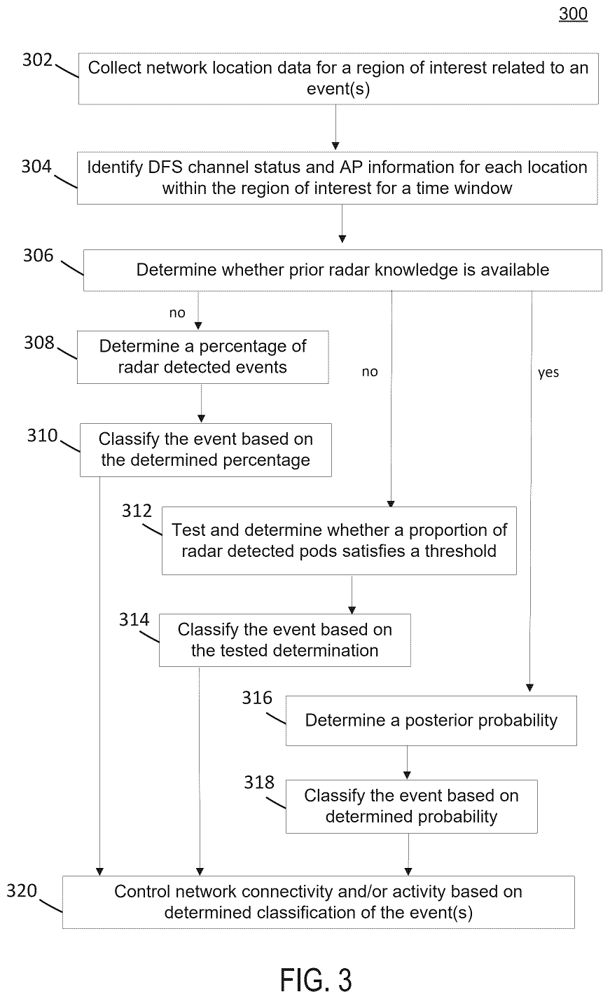

Turning to FIG. 3, Process 300 provides non-limiting example embodiments for the disclosed radar management and control framework for accurately and efficiently classifying a true radar event(s) for a specific region.

According to some embodiments, Steps 302 and 304 of Process 300 can be performed by identification module 202 of radar engine 200; Steps 306, 308, 312 and 316 can be performed by determination module 204; Steps 310, 314 and 318 can be performed by classification module 206; and Step 320 can be performed by control module 208.

According to some embodiments, Process 300 begins with Step 302 where engine 200 can collect network location data for a region of interest related to an event(s). In some embodiments, the discussion of Process 300's processing may be discussed with reference to a single event, which is for purposes of clarity; however, one of skill in the art should readily recognize that the processing discussed herein for the steps of Process 300 can be performed for a plurality of events, either sequentially occurring, simultaneously occurring (e.g., substantially simultaneous) and/or overlapping in some manner, without departing from the scope of the instant application.

In some embodiments, Step 302 can correspond to and/or be based on, but not limited to, detection of the event (e.g., based on periodic, criteria-based and/or continuous monitoring), a request, and the like, or some combination thereof. For example, engine 200 may receive a request from cloud system 106 to perform a check for a region of interest—for example, a geographic region (e.g., city, state, zip code, latitude and longitude lines, GPS defined area, and the like), for which the network location data, as discussed herein, can be compiled and collected as radar event reports, as discussed herein. In another example, upon detection of an event (e.g., a WiFi network attempting to use a DFS channel that interferes with a specific cellular communication at a specific time, then engine 200 can determine which region is covered by proximately located cell towers (e.g., gNodeBs), for which the region of interest can thereby be defined, from which reports can be compiled and collected, as discussed herein.

In some embodiments, the event, for example, can correspond to a communication event by and/or between a WiFi network(s) and/or device operating on the WiFi network (e.g., AP and/or UE, as discussed supra). According to some embodiments, the network location data can correspond to, but not be limited to, network statistics for each WiFi network (e.g., interference, latency, bandwidth, throughput, packet transmission data, and the like, for example), including the network activity and corresponding network statistics of the devices providing and/or accessing such networks, location data for such networks/devices, device information, and the like.

In some embodiments, a location can correspond to, but is not limited to, a home, office, building, and/or any other type of physical location that can be configured to host and/or provide network connectivity to devices in/around the geographic area. Accordingly, in some embodiments, the network(s), as discussed above, can be any type of communication network (e.g., a location-based or associated network such as a Wi-Fi network, for example) that can enable devices to automatically connect upon being within range of the location and/or access point devices providing the network at/around the location.

In some embodiments, the network location data can indicate, but not be limited to, a type of device, identity (ID) of device, MAC address or IP address of the device, user account associated the device, device designation (e.g., primary routers, repeaters, endpoints, and the like), device capabilities, connectivity data (or network statistics—for example, e.g., signal strength, signal quality, throughput, latency, bandwidth, and the like), connectivity type (e.g., which type of radio—for example, 2.4 GHz, 5 GHz and/or 6 GHz, for example; supported WiFi Standards (e.g., 802.11n, 802.11ac, 802.11ax); WiFi generations (e.g., WiFi 5/6/7, and the like) number of antennas (MIMO capabilities), and the like. Thus, the network location data for a region of interest can include a comprehensive set of data and/or metadata related to the real-world and/or digital networking activities for a time and/or time period.

In Step 304, engine 200 can identify (or collect) the DFS channel status and the AP information for each location within the region of interest for a specific time window. In some embodiments, the time window may correspond to a time from which the network location data is collected (from Step 302). In some embodiments, the time window may correspond to a time period before an event and/or after an event (e.g., Tuesday evening to Wednesday morning, as discussed in the above example).

In some embodiments, engine 200 can determine and identify (and thereby collect or retrieve) information related to the DFS status for each WiFi network at the locations in the region of interest for the time period. In some embodiments, the DFS status can correspond to the current operational state of an access point's DFS functionality, which can include, but is not limited to, the channel state, indicating whether a DFS channel is active, in use, or being monitored; reports on radar detection, revealing if any radar signals have been identified on the current channel, which is vital for avoiding interference with critical systems like weather radars, and the like. In some embodiments, the information can further correspond to a channel availability check (CAC) status, showing whether the access point is currently performing the mandatory check before utilizing a DFS channel. In some embodiments, if radar was previously detected, the DFS status can provide a non-occupancy period (NOP) status that indicates whether the access point is observing a required quiet period on that channel and how long it will last. The DFS status may also include information about channel switching, particularly if the access point is in the process of moving to a new frequency due to radar detection. Additionally, the status can provide or indicate a list of available DFS channels, which can change dynamically based on recent radar detections and NOPs. In some embodiments, transmit power adjustments made to comply with DFS regulations can be indicated. As discussed herein, such DFS status information provides capabilities for ensuring proper operation in shared frequency bands, thereby maintaining optimal performance and adhering to local regulatory requirements, as discussed herein.

In some embodiments, the AP information, for each location within the region of interest, can correspond to, but not be limited to, AP ID, service set identifier (SSID), AP model information, version information, number of connected devices, type of WiFi network being hosted, WiFi Standards supported, frequency bands, security protocols (e.g., WPA2, WPA3, and the like), MAC address, channel information, and the like, or some combination thereof.

In Step 306, engine 200 can determine whether prior radar knowledge is available. In some embodiments, such radar knowledge can be based on whether information for specific radios, radars, APs, UEs, networks, locations, time periods and/or regions of interest is retrievable from storage (e.g., database 108), for which radar information related to such networks, locations and/or components of the network can be identified and leveraged as prior radar knowledge.

According to some embodiments, as discussed herein, prior radar knowledge can play a crucial role in determining true or false radar events for DFS channels in WiFi networks. This knowledge encompasses several key aspects that help distinguish genuine radar signals from false positives, thereby improving the reliability of DFS systems.

Radar events (inclusive of radar pulses for weather radars, military radars, air traffic control radars, and the like) can include and/or be at certain widths, repetition frequencies, signal strengths, and the like. For example, weather radars often use specific pulse patterns that differ from those of military systems. Thus, such information can be used to accurately identify true radar events, as discussed herein.

Moreover, in some embodiments, such prior knowledge can include, but is not limited to, temporal and/or spatial factors that can contribute significantly to radar event verification. Knowledge of local radar installations, their operational schedules, and typical coverage areas can help contextualize detected signals. For example, if a WiFi network consistently detects potential radar signals at specific times that align with known radar operations in the area, it increases the likelihood of these being true events.

Further, in some embodiments, such prior knowledge can include, but is not limited to, the behavior of radar signals over time. Many radar systems employ frequency agility, changing their operating frequency periodically. Identifying such frequency-hopping patterns can help engine 200 differentiate true radar signals from random interference or false triggers.

Additionally, knowledge of signal propagation characteristics in different environments can aid in assessing the plausibility of detected radar events. Factors such as terrain, building materials, and atmospheric conditions can all affect how radar signals might be received by WiFi access points.

Furthermore, historical data, the regulatory environment and/or specific DFS requirements in different regions can be included in such information, whereby such knowledge can inform the sensitivity and specificity of radar detection algorithms/determinations, ensuring compliance while minimizing unnecessary channel switches.

Accordingly, in some embodiments, the determination in Step 306 can involve and/or be based on a computational analysis of the radar report information (from Steps 302 and/or 304) that involves the execution of an artificial intelligence and/or machine learning (AI/ML) model(s), which can be executable on the network, at the cloud and/or on the edge. According to some embodiments, such AI/ML model can be a specifically trained AI/ML model, a particular machine learning model architecture, a particular machine learning model type (e.g., convolutional neural network (CNN), recurrent neural network (RNN), autoencoder, support vector machine (SVM), and the like), or any other suitable definition of a machine learning model or any suitable combination thereof.

In some embodiments, engine 200 may be configured to utilize one or more AI/ML techniques selected from, but not limited to, computer vision, feature vector analysis, decision trees, boosting, support-vector machines, neural networks, nearest neighbor algorithms, Naive Bayes, bagging, random forests, logistic regression, and the like.

In some embodiments and, optionally, in combination of any embodiment described above or below, a neural network technique may be one of, without limitation, feedforward neural network, radial basis function network, recurrent neural network, convolutional network (e.g., U-net) or other suitable network. In some embodiments and, optionally, in combination of any embodiment described above or below, an implementation of Neural Network may be executed as follows:
a. define Neural Network architecture/model,
b. transfer the input data to the neural network model,
c. train the model incrementally,
d. determine the accuracy for a specific number of timesteps,
e. apply the trained model to process the newly received input data,
f. optionally and in parallel, continue to train the trained model with a predetermined periodicity.

In some embodiments and, optionally, in combination of any embodiment described above or below, the trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, and the like) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

Thus, in some embodiments, based on the analysis of the radar reports (from Steps 302 and 304), engine 200, in Step 306, can determine whether there is prior knowledge of how particular radar communications for each location within the region of interest will operate and/or their capabilities. As discussed below, given whether or not there is prior radar knowledge, engine 200 can perform three approaches: i) Steps 308 and 310 then Step 320; ii) Steps 312 and 314, then Step 320; and/or iii) Steps 316, 318 and 320.

According to some embodiments, when engine 200 determines that there is no prior radar knowledge currently available, as in Step 306, discussed supra, engine 200 can proceed to Step 308 where engine 200 can calculate a percentage of the radar detected events. For example, engine 200 can determine a percentage of the locations within the region of interest that detected the event (as per Step 302).

In Step 310, engine 200 can classify the event based on the determined percentage (from Step 308). For example, when the percentage of radar detected events is at or above a certain threshold, engine 200 can classify the event as a true event, and false otherwise. In some embodiments, the type and/or value of the threshold can be based on, but not limited to, the number of locations, volume of APs within and/or across the locations, type of event, type of WiFi network, and/or any other type of known or to be known value, feature and/or characteristic of the network location data, as discussed supra.

In some embodiments, upon classifying the event, a data structure(s) can be created with the event data, as well as network location data (discussed supra), included therein, with tags, annotations and/or other forms of information indicating the determined classification (as in Step 310). In some embodiments, a data structure per event, per region of interest and/or per location can be created. Such data structure(s) can be stored in database 108, and utilized to control the networks of such locations, as discussed infra in Step 320.

Turning back to Step 306, when engine 200 determines that there is no prior radar knowledge currently available, discussed supra, engine 200 can proceed to Step 312 where engine can test and determine whether a proportion of radar detected pods (e.g., APs and/or UEs, as discussed above respective to FIG. 1, for example) satisfy a threshold (e.g., referred to as “hypothesis testing”). For example, engine 200 can test if the collected data (from Steps 302 and/or 304) supports a claim of the proportion of radar detected pods being less than a certain threshold. In some embodiments, the type and/or value of the threshold can be based on, but not limited to, the number of locations, volume of APs within and/or across the locations, type of event, type of WiFi network, and/or any other type of known or to be known value, feature and/or characteristic of the network location data, as discussed supra.

In Step 314, engine 200 can classify the event based on the determined proportion from Step 312. For example, if the proportion is less than the threshold, then engine 200 can determine a classification of “no radar event” (and vice versa for the proportion being at or above the threshold).

Accordingly, in some embodiments, the processing in Steps 312-314 can involve, but is not limited to, initially defining a threshold p₀, where the null hypothesis is p=p₀, and the alternative hypothesis is p<p₀, where p is the actual proportion of radar detected pods (or AP, for example) for a type of pod within the region (e.g., as per functionality, band/radio supporting capabilities and/or manufacturer, for example).

Next, in some embodiments, engine 200 can calculate:

z=(\hat{p}−p₀)/p₀(1−p₀)/n, where \hat{p} is the observed percentage.

Next, in some embodiments, engine 200 can calculate: the one-tail p-value based on z. For example, if/when p-value<0.05 or 0.01, engine 200 can reject the null hypothesis, and can conclude that the event is a false alarm (e.g., no radar event detected).

In some embodiments, upon classifying the event, a data structure(s) can be created with the event data, as well as network location data (discussed supra), included therein, with tags, annotations and/or other forms of information indicating the determined classification (as in Step 314). In some embodiments, a data structure per event, per region of interest and/or per location can be created. Such data structure(s) can be stored in database 108, and utilized to control the networks of such locations, as discussed infra in Step 320.

In some embodiments, engine 200 can perform the classification operations of Steps 308-310 and/or Steps 312-314 when no prior radar knowledge is available. Such additional processing can be used to verify and/or confirm the accuracy, which can be performed on the back end or offline for such verification (for example, perform Steps 308-310, then, offline, perform Steps 312-314 to confirm the accuracy of the classification). Should the classifications not match, engine 200 can repeat one or both classification approaches.

Turning back to Step 306, when engine 200 determines that there is prior radar knowledge available, engine 200 can determine a posterior probability, as in Step 316. In some embodiments, such prior radar knowledge can be based on the current radar reports (as per Steps 302-304, for example).

According to some embodiments, the determination in Step 316 can involve calculations where:

T(F) being the event when there is (or is not) a radar event, and Pi(Ni) being the event when a particular pod (e.g., AP) model i (does or does not) report a radar event. Accordingly, the probability of a true radar event when the number of Pi=ni and Ni=mi can be:

$$P r ( T \vert \# ( Pi ) = ni , \# ( Ni ) = mi ∀ i ) = Pr ( \# ( Pi ) = ni , \\ \# ( Ni ) = mi ∀ i ) \vert T ) P r ( T ) / Pr ( \# ( Pi ) = n i , \# ( Ni ) = mi ∀ i )$$

According to some embodiments, the information needed to collect is the probability of having a radar Pr(T) in the past, and the probability of correctly detecting a radar when there is a radar event for the model (e.g., which can be used for true labeling of a threshold satisfying portion of past events).

In some embodiments, such posterior probability determination can be subject to the above calculations being executed via any of the AI/ML models discussed above.

In Step 318, upon determining the posterior probability in Step 316, engine 200 can classify the event—for example, if the determined posterior probability indicates that the event is a true or false event, then such probability can be followed via the classification.

In some embodiments, upon classifying the event, a data structure(s) can be created with the event data, as well as network location data (discussed supra), included therein, with tags, annotations and/or other forms of information indicating the determined classification (as in Step 318). In some embodiments, a data structure per event, per region of interest and/or per location can be created. Such data structure(s) can be stored in database 108, and utilized to control the networks of such locations, as discussed infra in Step 320.

And, in Step 320, upon determining the classifications of the event(s) as in Steps 308-310 and/or Steps 312-314 (when no prior radar knowledge was available), or in Steps 316-318, engine 200 can perform operations, via the created data structures (discussed above) to control network connectivity and/or control AP and/or UE activity therewithin such locations.

For example, engine 200 can compile and execute controls based on the classified radar event (e.g., each event's data structure which was created upon the classification, for example, as discussed above) that can manipulate, modify and/or optimize each location's network, such that, among other technical controls, can alter the DFS mode settings of APs, UEs and/or WiFi networks as a whole for particular locations. For example, network topologies can be modified, DFS channels can be rendered inaccessible for periods of time, connectivity to specific antennas of an AP can be turned off for specific periods of time, and the like. Such controls, therefore, can improve how such networks operate in avoiding (and/or mitigating) interference and network downtime, among other technical benefits, as well as improve user experience for network device users.

Accordingly, as discussed herein, the disclosed framework can compile controls and/or executable instructions that can manipulate, modify and/or optimize networks within particular regions of interest in order to, for example, control, manage (e.g., alter) the DFS mode settings of APs, UEs and/or WiFi networks as a whole for particular locations, which can enable capabilities for such networks to avoid forms of interference and/or degradation that can be caused by overlapping DFS operations.

FIG. 6 is a schematic diagram illustrating a client device showing an example embodiment of a client device that may be used within the present disclosure. Client device 600 may include many more or less components than those shown in FIG. 6. However, the components shown are sufficient to disclose an illustrative embodiment for implementing the present disclosure. Client device 600 may represent, for example, UE 102 discussed above at least in relation to FIG. 1.

As shown in the figure, in some embodiments, Client device 600 includes a processing unit (CPU) 622 in communication with a mass memory 630 via a bus 624. Client device 600 also includes a power supply 626, one or more network interfaces 650, an audio interface 652, a display 654, a keypad 656, an illuminator 658, an input/output interface 660, a haptic interface 662, an optional global positioning systems (GPS) receiver 664 and a camera(s) or other optical, thermal or electromagnetic sensors 666. Device 600 can include one camera/sensor 666, or a plurality of cameras/sensors 666, as understood by those of skill in the art. Power supply 626 provides power to Client device 600.

Client device 600 may optionally communicate with a base station (not shown), or directly with another computing device. In some embodiments, network interface 650 is sometimes known as a transceiver, transceiving device, or network interface card (NIC).

Audio interface 652 is arranged to produce and receive audio signals such as the sound of a human voice in some embodiments. Display 654 may be a liquid crystal display (LCD), gas plasma, light emitting diode (LED), or any other type of display used with a computing device. Display 654 may also include a touch sensitive screen arranged to receive input from an object such as a stylus or a digit from a human hand.

Keypad 656 may include any input device arranged to receive input from a user. Illuminator 658 may provide a status indication and/or provide light.

Client device 600 also includes input/output interface 660 for communicating with external. Input/output interface 660 can utilize one or more communication technologies, such as USB, infrared, Bluetooth™, or the like in some embodiments. Haptic interface 662 is arranged to provide tactile feedback to a user of the client device.

Optional GPS transceiver 664 can determine the physical coordinates of Client device 600 on the surface of the Earth, which typically outputs a location as latitude and longitude values. GPS transceiver 664 can also employ other geo-positioning mechanisms, including, but not limited to, triangulation, assisted GPS (AGPS), E-OTD, CI, SAI, ETA, BSS or the like, to further determine the physical location of client device 600 on the surface of the Earth. In one embodiment, however, Client device 600 may through other components, provide other information that may be employed to determine a physical location of the device, including for example, a MAC address, Internet Protocol (IP) address, or the like.

Mass memory 630 includes a RAM 632, a ROM 634, and other storage means. Mass memory 630 illustrates another example of computer storage media for storage of information such as computer readable instructions, data structures, program modules or other data. Mass memory 630 stores a basic input/output system (“BIOS”) 640 for controlling low-level operation of Client device 600. The mass memory also stores an operating system 641 for controlling the operation of Client device 600.

Memory 630 further includes one or more data stores, which can be utilized by Client device 600 to store, among other things, applications 642 and/or other information or data. For example, data stores may be employed to store information that describes various capabilities of Client device 600. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within Client device 600.

Applications 642 may include computer executable instructions which, when executed by Client device 600, transmit, receive, and/or otherwise process audio, video, images, and enable telecommunication with a server and/or another user of another client device. Applications 642 may further include a client that is configured to send, to receive, and/or to otherwise process gaming, goods/services and/or other forms of data, messages and content hosted and provided by the platform associated with engine 200 and its affiliates.

According to some embodiments, certain aspects of the instant disclosure can be embodied via functionality discussed herein, as disclosed supra. According to some embodiments, some non-limiting aspects can include, but are not limited to the below method aspects, which can additionally be embodied as system, apparatus and/or device functionality:
Aspect 1. A method comprising:
   receiving a radar event report, the radar event report comprising information related to a radar event for a set of locations within a region, the set of locations each having a WiFi network;
   analyzing the radar event report, and determining whether prior knowledge related to the radar event is available;
   determining, based on the prior knowledge determination, a type of metric that corresponds to a value of the radar event across the set of locations;
   classifying the radar event based on the determined type of metric; and
   controlling each WiFi network at the set of locations based on the classification of the radar event.
Aspect 2. The method of aspect 1, further comprising:
   determining a percentage of radar detected events for the set of locations; and
   classifying the radar event based on a comparison between the determined percentage of radar detected events and a threshold, the threshold being based on information related to the radar event.
Aspect 3. The method of aspect 2, wherein the type of metric is the determined percentage of radar detected events, wherein the determination of the percentage of radar detected events is performed when prior knowledge is not available.
Aspect 4. The method of aspect 1, further comprising:
   determining a proportion of radar detected access points (APs) across the set of locations; and
   determining whether the determined proportion satisfies a threshold, the threshold being based on information related to the radar event.
Aspect 5. The method of aspect 4, further comprising:
   performing the classification of the radar event based on the determination of whether the determined proportion satisfies the threshold.
Aspect 6. The method of aspect 4, wherein the determination of the proportion of radar detected APs is performed when prior knowledge is not available, wherein the type of metric is the determined proportion of radar detected APs.
Aspect 7. The method of aspect 1, further comprising:
determining a posterior probability for the radar event, the posterior probability being based on the prior radar knowledge; and
performing the classification of the radar event based on determined posterior probability.
Aspect 8. The method of aspect 1, further comprising:
creating, based on the classification, data structure for the radar event; and
performing the control of each of the WiFi networks via the data structure.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, and the like).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, API, instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, and the like).

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
receiving a radar event report, the radar event report comprising information related to a radar event for a set of locations within a region, the set of locations each having a WiFi network;
analyzing the radar event report, and determining whether prior knowledge related to the radar event is available;
determining, based on the prior knowledge determination, a type of metric that corresponds to a value of the radar event across the set of locations;
classifying the radar event based on the determined type of metric; and
controlling each WiFi network at the set of locations based on the classification of the radar event.

2. The method of claim 1, further comprising:
determining a percentage of radar detected events for the set of locations; and
classifying the radar event based on a comparison between the determined percentage of radar detected events and a threshold, the threshold being based on information related to the radar event.

3. The method of claim 2, wherein the type of metric is the determined percentage of radar detected events, wherein the determination of the percentage of radar detected events is performed when prior knowledge is not available.

4. The method of claim 1, further comprising:
determining a proportion of radar detected access points (APs) across the set of locations; and
determining whether the determined proportion satisfies a threshold, the threshold being based on information related to the radar event.

5. The method of claim 4, further comprising:
performing the classification of the radar event based on the determination of whether the determined proportion satisfies the threshold.

6. The method of claim 4, wherein the determination of the proportion of radar detected APs is performed when prior knowledge is not available, wherein the type of metric is the determined proportion of radar detected APs.

7. The method of claim 1, further comprising:
determining a posterior probability for the radar event, the posterior probability being based on the prior radar knowledge; and
performing the classification of the radar event based on determined posterior probability.

8. The method of claim 1, further comprising:
creating, based on the classification, data structure for the radar event; and
performing the control of each of the WiFi networks via the data structure.

9. A system comprising:
a processor configured to:
receive a radar event report, the radar event report comprising information related to a radar event for a set of locations within a region, the set of locations each having a WiFi network;
analyze the radar event report, and determine whether prior knowledge related to the radar event is available;
determining, based on the prior knowledge determination, a type of metric that corresponds to a value of the radar event across the set of locations;
classifying the radar event based on the determined type of metric; and
controlling each WiFi network at the set of locations based on the classification of the radar event.

10. The system of claim 9, wherein the processor is further configured to:
determine a percentage of radar detected events for the set of locations; and
classify the radar event based on a comparison between the determined percentage of radar detected events and a threshold, the threshold being based on information related to the radar event.

11. The system of claim 10, wherein the type of metric is the determined percentage of radar detected events, wherein the determination of the percentage of radar detected events is performed when prior knowledge is not available.

12. The system of claim 9, wherein the processor is further configured to:
determine a proportion of radar detected access points (APs) across the set of locations; and
determine whether the determined proportion satisfies a threshold, the threshold being based on information related to the radar event.

13. The system of claim 12, wherein the processor is further configured to:
perform the classification of the radar event based on the determination of whether the determined proportion satisfies the threshold.

14. The system of claim 12, wherein the determination of the proportion of radar detected APs is performed when prior knowledge is not available, wherein the type of metric is the determined proportion of radar detected APs.

15. The system of claim 9, wherein the processor is further configured to:
determine a posterior probability for the radar event, the posterior probability being based on the prior radar knowledge; and
performing the classification of the radar event based on determined posterior probability.

16. The system of claim 9, wherein the processor is further configured to:
create, based on the classification, data structure for the radar event; and
perform the control of each of the WiFi networks via the data structure.

17. A non-transitory computer-readable storage medium tangibly encoded with computer-executable instructions that when executed by a processor, perform a method comprising steps of:
receiving a radar event report, the radar event report comprising information related to a radar event for a set of locations within a region, the set of locations each having a WiFi network;
analyzing the radar event report, and determining whether prior knowledge related to the radar event is available;
determining, based on the prior knowledge determination, a type of metric that corresponds to a value of the radar event across the set of locations;
classifying the radar event based on the determined type of metric; and
controlling each WiFi network at the set of locations based on the classification of the radar event.

18. The non-transitory computer-readable storage medium of claim 17, further comprising:
determining a percentage of radar detected events for the set of locations; and
classifying the radar event based on a comparison between the determined percentage of radar detected events and a threshold, the threshold being based on information related to the radar event.

19. The non-transitory computer-readable storage medium of claim 17, further comprising:
determining a proportion of radar detected access points (APs) across the set of locations;
determining whether the determined proportion satisfies a threshold, the threshold being based on information related to the radar event; and
performing the classification of the radar event based on the determination of whether the determined proportion satisfies the threshold.

20. The non-transitory computer-readable storage medium of claim 17, further comprising:
determining a posterior probability for the radar event, the posterior probability being based on the prior radar knowledge; and
performing the classification of the radar event based on determined posterior probability.
